(19) United States
(12) Patent Application Publication
(10) Pub. No.: US 2012/0071184 A1
(43) Pub. Date: Mar. 22, 2012

(54) BASE STATION HAVING A PLURALITY OF LOGICAL BASE STATIONS

(75) Inventor: Jie Lin, Basingstoke (GB)

(73) Assignee: Huawei Technologies Co., Ltd., Shenzhen (CN)

(21) Appl. No.: 13/305,748

(22) Filed: Nov. 29, 2011

Related U.S. Application Data
(63) Continuation of application No. PCT/CN2009/072103, filed on Jun. 3, 2009.

(51) Int. Cl. H04W 88/10; H04W 4/00

(52) U.S. Cl. 455/507; 455/552.1

(57) ABSTRACT

The present disclosure relates to a base station for communicating in a communication system using different communication technologies. The base station includes a first logical base station being configured to communicate according to a first communication technology, and a second logical base station being configured to communicate according to a second communication technology, the second communication technology being different from the first communication technology.

### CROSS-REFERENCE TO RELATED APPLICATIONS

This application is a continuation of International Application No. PCT/CN2009/072103, filed on Jun. 3, 2009, which is hereby incorporated herein by reference in its entirety.

### BACKGROUND

The present invention relates to communication technologies, and in particular to a communication system using logical base stations.

Building, expanding and upgrading radio communication systems, such as a 2^{nd} generation system, e.g. a Global System for Mobile Communications (GSM) or a 3^{rd} Generation Partnership Project (3GPP) system, e.g. a Universal Mobile Telecommunications System (UMTS), involves enormous costs when good coverage should be achieved. In order to achieve sufficient coverage over the whole geographical area being covered by the radio communication system, a very large number of base stations have to be built, which is expensive.

For example, a system operator normally has to provide a sufficient coverage for more or less the whole geographical area of a country, in which the system operator provides its services in order to be commercially successful. Especially, in some geographical areas, in which there is relatively low activity in the radio communication system, offering adequate coverage by building a full Radio Access Network (RAN) completely covering that area is rarely profitable.

Thus, in a traditional radio communication system, each communication system operator has to make extensive investments in order to provide sufficient coverage for its customers. Also, when new technologies are rolled out, each system operator has to upgrade its RAN accordingly, which is also costly.

Recently, there has been a clear trend in the market place for operators of communication systems to share communication resources, in particular communication networks. However, the upcoming refarming of the 900 MHz/1800 MHz frequency bands currently reserved for GSM, UMTS and LTE (Long Term Evolution) technologies requires a considerable amount of additional capital expenditures (CAPEX). Furthermore, operating expenditures (OPEX) tend to increase when multiple networks, e.g. GSM, UMTS or LTE networks, are maintained. In addition, new site acquisitions also are associated with increasing difficulties due to public objections.

In order to solve the above-indicated problems, system operators have started to share their RANs with each other. Basically, physical base stations and control nodes in the radio communication system are shared by a number of system operators.

The physical base stations are divided into a number of logical base stations, such that radio resources of such a physical base station are shared by a number of logical base stations. A logical base station is a virtual base station, which can function independently to perform essentially all radio communication functions a physical base station would normally be expected to perform.

### SUMMARY OF THE INVENTION

The present disclosure is based on the finding that the available communication resources may more efficiently be exploited if different logical base stations, i.e. virtual base stations, associated with different communication technologies, e.g. GSM or UMTS or LTE, are arranged within the same base station which may be a physical base station or a superordinate logical, i.e. virtual, base station.

The invention enables different operators of a communication system to communicate via the same base station using different communication technologies which increases a rural coverage and a capacity for further expansions at reduced network service costs. Furthermore, the multi-base station concept enables multiple operators of the same network to share communication resources, e.g. a RAN or a Software Defined Radio (SDR). By way of example, a GSM operator may share communication resources with a UMTS operator or the GSM operator may share communication resources with a LTE operator or the UMTS operator may share communication resources with the LTE operator. Furthermore, the GSM communication technology and the UMTS communication technology or the GSM communication technology and the LTE communication technology or the UMTS technology and the LTE technology may simultaneously be used over a single RAN and/or over a single SDR by operators sharing the same physical network.

The invention relates to a base station for communication in a communication system using different communication technologies. Preferably, the base station includes a first logical base station being configured to communicate according to a first communication technology, and a second logical base station being configured to communicate according to a second communication technology which is different from the first communication technology. The first logical base station and the second logical base station may be arranged within an actual base station, which may be a physical base station or a superordinate logical base station. Furthermore, the first logical base station and the second logical base station may be daisy-chained and/or arranged to support different operators or a same operator of the communication system using different communication technologies such as GSM, UMTS or LTE.

According to an aspect of the present disclosure, the first logical base station may be assigned to a first control node which may be a first base station or radio network controller, and/or to a first operator of the communication system communicating according to the first communication technology. Accordingly, the second logical base station may be assigned to a second control node, in particular to a second base station or radio network controller, and/or to a second operator of the communication system communicating according to the second communication technology. Thus, the first logical base station and the second logical base station may directly communicate with the respective control node according to e.g. different communication technologies. The control nodes may be arranged within or outside the base station.

According to another aspect of the present disclosure, the first logical base station and/or the second logical base station may respectively be arranged to communicate according to a plurality of communication technologies. For example, the first logical base station may be arranged to communicate according to the first and according to the second communication technology. Accordingly, the second logical base station may be arranged to communicate according to the first and according to the second communication technology. In this case, each logical base station may form a logical base band unit respectively comprising at least two subordinate logical base stations, i.e. a subordinate first logical base station and a subordinate second logical base station, each being arranged to communicate according to one of the implemented communication technologies, e.g. GSM, UMTS or LTE or any other wireless or wired communication technology. Thus, an operator of the communication system may communicate according to a plurality of communication technologies via the same base station and the same logical base station or base band unit. It shall be noted for the sake of clarity that the following description applies to logical base stations and to superordinate and to subordinate logical base stations.

According to yet another aspect of the present disclosure, the first logical base station may include a communication controller for controlling communication according to the first communication technologies. Accordingly, the second logical base station may include a communication controller for communicating according to the second communication technology. The first communication controller and the second communication controller may e.g. be programmably arranged on a controller card to support e.g. the GSM, UMTS or LTE technology.

According to another aspect of the present disclosure, the first logical base station and the second logical base station may respectively include a plurality of communication controllers being respectively arranged to control communication according to a plurality of communication technologies. For example, the first logical base station may include a first communication controller for controlling communication according to the first communication technology and a second communication controller for controlling communication according to the second or to a further communication technology. Accordingly, the second logical base station may include a first communication controller for controlling communication according to the first communication technology and a second communication controller for controlling communication according to the second or to a further communication technology. For example, the respective communication controller may be formed by a GSM site controller and transmission card (GTMU), or a Wide Band Code Division Multiple Access (WCDMA) base band processing card (WBBP) or by a WCDMA controller and transmission card (WMBT).

According to another aspect of the present disclosure, the base station is configured to communicate according to the first communication technology and according to the second communication technology using at least partly the same or distinct communication resources, in particular a frequency band or a frequency carrier or a transmission bandwidth or a transmission power. For example, the physical layer of the base station according to which the physical communication is ruled may be arranged to support e.g. reception or transmission of signals according to different communication technologies sharing the same physical resources, e.g. the same frequency bandwidth.

According to another aspect of the present disclosure, the base station may include a radio frequency module for communicating within a certain frequency band. However, the radio frequency module may be arranged to communicate within a plurality of certain frequency bands. Thus, the radio frequency module may be a single-band or a multi-band radio frequency module. Moreover, the base station may include a single antenna or a multiple antenna arrangement for communicating within the certain frequency band or within a plurality of certain frequency bands according to the single input single output (SISO), single input multiple output (SIMO), multiple input single output (MISO) or multiple input multiple output (MIMO) communication approach. The radio frequency module may be a multi-standard radio function module (mRFU) which may be arranged within the base station. However, the radio frequency module may also form a multi-standard remote radio module (mRRU) being arranged outside the base station cabinet at the antenna.

According to yet another aspect of the present disclosure, the base station is a physical base station programmably arranged to include the first logical, i.e. virtual, base station and the second logical, i.e. virtual, base station. For example, the logical base stations may be implemented on programmably arranged entities, e.g. microprocessors, specifically arranged to perform the operations of the respective logical base station.

According to another aspect of the present disclosure, the base station may be configured to receive a multiplexed signal comprising a first signal according to the first communication technology and a second signal according to the second communication technology. In other words, the first and the second signal may be provided to the base station in a multiplexed manner according e.g. to the ATM approach (ATM: Asynchronous Transfer Mode). Preferably, the base station is configured to extract the first signal and/or the second signal from the multiplexed signal and to provide the first signal to the first logical base station and/or to provide the second signal to the second logical base station. In order to extract the respective signal, the base station may demultiplex the multiplexed signal according to any of the known demultiplexing schemes.

According to another aspect of the present disclosure, the base station may include a plurality of logical base stations, each logical base station being associated with a different communication technology and a different or the same operator of the communication system. Therefore, different operators communicating according to different communication technologies can communicate via the same base station. Moreover, the base station may also be configured to support operators communicating via different communication technologies. In this case, the base station may include a plurality of logical base stations associated with the same operator, each logical base station being associated with a different communication technology. In order to support a plurality of such operators, the base station may further include a multiplicity of such plurality of logical base stations respectively forming logical base band units.

According to another aspect of the present disclosure, the first communication technology and/or the second communication technology may be one of the following communication technologies: UMTS, GSM, LTE or Code Division Multiple Access 2000 (CDMA 2000), by way of example. However, the first communication technology or the second communication technology may be associated with further known communication technologies within the mobile or wired communication environment.

Above mentioned aspects of the present disclosure may be combined with each other.

The invention further relates to a communication system, for example to a radio communication system, comprising the base station for communicating according to different communication technologies, a first control node, for example a base station or radio network controller, for communicating with the first logical base station of the base station according to the first communication technology, and a second control node, in particular a base station or radio network controller, for communicating with the second logical base station of the base station according to the second communication technology. The control nodes are arranged to provide for a direct access to the respective logical base station for communicating according to the first communication technology and/or according to the second communication technology.

Above mentioned aspects of the disclosure of the base station may be combined with each other to form the disclosure of the communication system.

According to an aspect of the present disclosure, the communication system may further include a multiplexer for connecting the first control node and the second control node to the base station. Preferably, the multiplexer is configured to multiplex signals received from the first control node and the second control node to obtain a multiplexed signal to be provided to the base station for further processing.

The invention further relates to a method for communicating in a communication system using different communication technologies, and preferably the same, e.g. physical, base station. The method includes communicating according to the first communication technology using a first logical base station being arranged within the base station, and communicating according to a second communication technology using a second logical base station being arranged within the base station.

Further steps of the method for communicating in the communication system using different communication technologies are directly derivable from the functionality of the base station for communicating in a communication system using different communication technologies.

The invention further relates to a computer program comprising a program code for executing the method for communicating in a communication system according to different communication technologies when run in a computer.

### BRIEF DESCRIPTION OF THE DRAWINGS

Embodiments of the invention will be described with respect to the following figures, in which:

FIG. 1 shows an example of a communication system having a base station which comprises a plurality of logical base stations; and

FIG. 2 shows another example of a communication system having a base station which comprises a plurality of logical base stations.

### DETAILED DESCRIPTION OF THE INVENTION

Before the invention is described in detail, it is to be understood that this invention is not limited to the particular component parts of the devices described or steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

Although known RAN sharing approaches enable multiple operators to share a single communication technology, i.e. either GSM or UMTS or LTE technology, they are not intended to support multiple operators concurrently employing different technologies, such as GSM and UMTS, GSM and LTE, UMTS and LTE or GSM and UMTS, to share the same RAN. This problem will become a major issue for operators employing a single RAN in connection with a Software Defined Radio (SDR) or a Multi-Standard Radio (MSR) to share the refarming operation in particular for GSM and UMTS, GSM and LTE or UMTS and LTE. In particular, the known RAN sharing solutions are solely based on a logical separation of a single technology RAN. A key element of these approaches is to create multiple logical RANs or base transceiver stations (BTS) using a single communication technology such as GSM or UMTS or LTE sharing the same physical resources, for example the same radio frequencies.

The above mentioned limitations associated with the inability of sharing a single RAN or SDR or MSR have the disadvantage that any RAN sharing between e.g. a GSM operator and a UMTS operator or between a GSM operator and LTE operator or between a UMTS operator and a LTE operator in the same frequency band is not supported. Furthermore, any RAN sharing between operators employing e.g. GSM and UMTS or GSM and LTE or UMTS and LTE concurrently in the same frequency band is not possible. Therefore, the available communication resources are not efficiently exploited if, within the same communication system, different communication technologies, e.g. GSM or UMTS or LTE, are used by the same or by different operators of the communication systems.

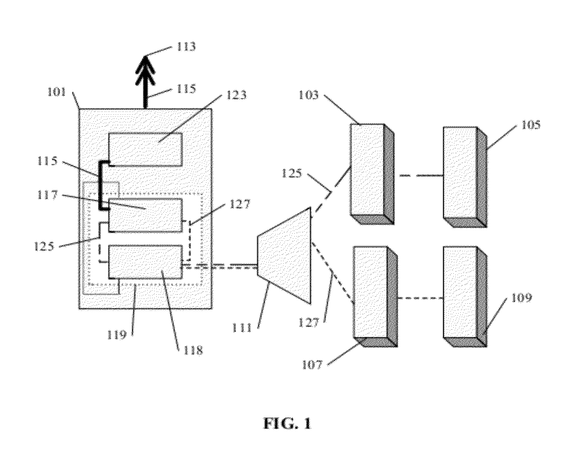

As an embodiment of the invention, FIG. 1 shows a base station 101 being arranged within a communication system comprising a first control node 103, e.g. a base station or radio network controller (BSC or RNC), a first operation and maintenance centre 105, a second control node 107, e.g. a radio network controller (RNC), and a second operation and maintenance centre 109. The first control node 103 and the first operation and maintenance centre 105 are by way of example associated with a first operator. Accordingly, the second control node 107 and the second operation and maintenance centre 109 may be associated with a second operator of the communication network.

The first control node 103 and the second control node 107 provide respective signals according to different communication technologies to a multiplexer 111 which is arranged to multiplex these signals to a multiplexed signal which is provided to the base station 101. The communication system further includes an antenna 113 connected to the base station 101 via e.g. a cable 115.

The base station 101 includes a first logical base station 117 for communicating according to a first communication technology, e.g. for communicating according to the GSM communication technology. The base station 101 further includes a second logical base station 118 for communicating according to a second communication technology, for example according to the UMTS communication technology. The first logical base station 117 and the second logical base station 118 may be daisy-chained via a common public radio interface (CPRI). The logical base stations 117 and 118 may respectively form a virtual base transceiver station (BTS) created for each operator with a dedicated communication controller according to a respective communication technology. Furthermore, each logical base station 117 and 118 may form a logical base band unit, the base band units being interconnected to a shared base band unit complex 119 by a connection 121 representing the CPRI, by way of example.

The first logical base station 117 may e.g. include a GSM site controller and a transmission card (GTMU) forming an embodiment of a communication controller for controlling communications according to the GSM communication technology. Accordingly, the second logical base station 118 may include a WCDMA base band processing card and/or a WCDMA controller and a transmission card, WBBP or WMPT, forming an embodiment of a communication controller for controlling communication according to the UMTS standard.

The base station further includes a radio frequency module 123, which may be a multi-standard radio function unit (mRFU) or a multi-standard remote radio unit (mRRU). The radio frequency module 123 is arranged to communicate with the antenna 113 via the cable 115.

According to FIG. 1, at least two operators share the same base station 101, i.e. the same BTS system, including e.g. the antenna 113, feeders which are not shown in FIG. 1, and radio frequency modules, e.g. RRU or RFU. Furthermore, at least two operators may share the same BTS cabinet including a power supply, a battery backup and any other site utilities (not shown). Thus, the logical base stations 117 and 118 may also share the mRFU and/or the mRRU and the BTS cabinet.

As shown in FIG. 1, a signal 125 associated with the first operator and a signal 127 associated with the second operator are multiplexed by the multiplexer 111 to form a multiplexed signal 129. The multiplexed signal 129 is then provided to the base station 101, where the multiplexed signal is demultiplexed and distributed to the logical base stations 117 and 118 respectively as depicted in FIG. 1.

The common connection of the system's entities with the base station 101 via the multiplexer 111 also enables sharing backhaul transmissions between the base band unit complex 119 (formed by the logical base stations 117 and 118) and the multiplexer 111.

As depicted in FIG. 1, by way of example, the first logical base station 117 processes the first signal 125 of the first operator, which signal may be a GSM signal. Correspondingly, the second logical base station 118 processes the second signal 127 according to the second operator, which signal may be a UMTS signal. However, the first and the second operator may share the same frequency band via which the GSM and UMTS signals may be transmitted or received. Thus, the first operator and the second operator may share the first logical base station 117 and the second logical base station 118, which enables each of the operators to communicate according to at least two communication technologies, e.g. according to the GSM technology and according to the UMTS technology. The distribution of the respective signals to the respective logical base station 117 and/or 118 may be performed e.g. upon a basis of logical addresses or further identifiers enabling associating signals of a respective operator with the corresponding logical base station 117 or 118. The sharing of the logical base stations 117 and 118 may further be transparent to the control nodes 103 and 107.

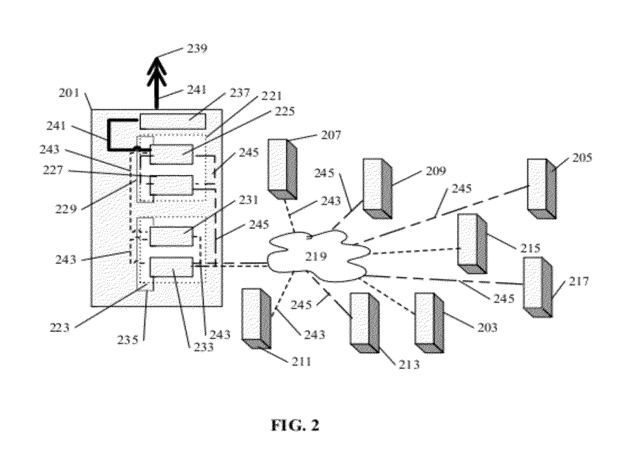

As another embodiment of the invention, FIG. 2 shows a base station 201 arranged within a communication system comprising a first control node 203, e.g. a BSC, associated with a first operator and a second control node 205, e.g. a BSC associated with a second operator. The communication system may further include a first mobility management entity (MME) 207 associated with the first operator and a second MME 209 associated with the second operator. Furthermore, the system may further include a first operation and maintenance centre 211 associated with the first operator and a second operation and maintenance centre 213 associated with the second operator. The system may further include a first serving gateway (GW) 215 associated with the first operator and a second serving gateway 217 associated with the second operator. The base station 201 and the above described entities 203 to 217 may be arranged to communicate via a transmission network 219, which may be a wireless or a wired transmission network.

The base station 201 includes a first logical base band unit 221 and a second logical base band unit 223. The first logical base band unit 221 and the second logical base band unit 223 may be, by way of example, daisy-chained to form a base band unit complex. The base station 201 may, however, include more than two logical base band units, each comprising two or more logical base stations arranged in correspondence to the embodiment of FIG. 2 to support a plurality of operators respectively communicating according to one or more communication technologies.

The first logical base band unit 221 may include a first logical, i.e. virtual, base station 225 and a second logical base station 227. The first logical base station 225 and the second logical base station 227 may be interconnected via the connection 229 representing e.g. the CPRI. By way of example, the first logical base station 225 may be arranged to support communication according to the GSM communication technology. Thus, the first logical base station 225 may include a communication controller, e.g. a GSM site controller and transmission card (GTMU) for controlling communication according to the GSM communication technology. The second logical base station 227 may be arranged to support communication according to a second communication technology, e.g. according to the LTE communication technology. Thus, the second logical base station 227 may include a communication controller, e.g. a LTE controller and a transmission card (LMPT).

Accordingly, the second logical base band unit 223 may include a first logical base station 231 and a second logical base station 233 being e.g. interconnected via the connection 235 representing e.g. the CPRI and arranged to support communications according to different communication technologies. For example, the first logical base station 231 and the second logical base station 233 of the second logical base band unit 223 may be arranged to respectively correspond to the first logical base station 225 and to the second logical base station 227 of the first logical base band unit 221. Thus, the first logical base station 231 of the second logical base band unit 223 may be arranged to include a GTMU for controlling communication according to the GSM communication technology. Accordingly, the second logical base station 233 of the second logical base band unit 223 may include a LMPT to control communication according to the LTE communication technology. However, the first logical base station 231 and the second logical base station 233 of the second logical base band unit 223 may be arranged to support further communication technologies, e.g. UMTS and LTE or GSM and UMTS.

The base station 201 may further include a radio frequency module 237, e.g. a mRFU and/or a mRRU, which is connected with an antenna 239 of the communication signal via the cable 241.

As shown in FIG. 2, the signals 243 associated with the first operator and the signals 245 associated with the second operator are provided to the base station 201 and distributed to the respective logical base band unit 221 and 223. For example, both operators may concurrently communicate according to the GSM and LTE communication technology in the same frequency band. In this regard, the operators may share the same base station 201 comprising the BTS system including the antenna 239, feeders not shown in FIG. 2, the RF module 237, a BTS cabinet including a power supply or a battery backup and any other site utility (not shown).

Still in reference to FIG. 2, a virtual BTS may be created by virtue of the respective logical base stations 225, 227, 231 and 233 for each operator with a dedicated base band unit 221 and 223 which may be daisy-chained via the CPRI to form a base band unit complex. As depicted in FIG. 2, one or more control nodes, e.g. BSCs, operation and maintenance centers and system architecture evolution entities (SAE) including the mobility management entities and the serving gateways may be dedicated for each operator. However, the operators may communicate via the same base station 201 and thus share the BTS which may be transparent to the control nodes and to the SAE.

Since each logical base band unit 221 and 223 supports a plurality of different communication technologies, each operator may communicate according to different communication technologies by virtue of a virtual BTS sharing even in a single RAN scenario. Thus, a single RAN logical base station can be created by using the virtual BTS concept employing e.g. different types of communication controllers, e.g. different types of controller cards, to form a logical RAN respectively supporting a different single communication technology and a single LAN and SDR or MSR, i.e. multi-mode or multi-communication technologies.

The integration of a plurality of logical base stations being associated with different communication technologies such as GSM, UMTS and LTE or any number of none-repetitive combinations of these three communication technologies within a single physical base station allows for multiple operators to operate according to different communication technologies and to share the same physical resources, including the base station, the antenna, the feeders etc. The multiple logical base station concept further supports a RAN sharing between e.g. a GSM operator and a UMTS operator or between a GSM operator and a LTE operator or between a UMTS operator and a LTE operator within the same frequency band which significantly reduces network operation costs. Furthermore, the multiple logical base station concept supports RAN sharing between operators which are concurrently operating within the same frequency band according to the GSM communication technology and the UMTS communication technology or according to the GSM communication technology and the LTE communication technology or according to the UMTS communication technology and the LTE communication technology which also reduces network operation costs.

The particular combinations of elements and features in the above detailed embodiments are exemplary only; the interchanging and substitution of these embodiments with other embodiments disclosed herein are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

What is claimed is:

1. A base station for conducting communications in a communication system using different communication technologies, comprising:
a first logical base station, configured to conduct communications according to a first communication technology; and
a second logical base station, configured to conduct communications according to a second communication technology,
wherein the second communication technology is different from the first communication technology.

2. The base station according to claim 1, wherein
the first logical base station is connected to a first control node, and the first control node is a first base station controller or a first radio network controller associated with a first operator of the communication system communicating according to the first communication technology,
the second logical base station is connected to a second control node, and the second control node is a second base station controller or a second radio network controller associated with a second operator of the communication system communicating according to the second communication technology,
wherein the first and the second operators are different or same.

3. The base station according to claim 1, wherein the first logical base station comprises a communication controller configured to control communications according to the first communication technology; the second logical base station comprises a communication controller configured to control communications according to the second communication technology.

4. The base station according to claim 1, wherein each of the first logical base station and the second logical base station comprises a first communication controller configured to control communications according to the first communication technology and a second communication controller configured to control communications according to the second or to a further communication technology.

5. The base station according to claim 1, wherein the base station is configured to communicate according to the first communication technology and according to the second communication technology; wherein communicating according to the two communication technologies uses at least partly the same or distinct communication resources, and wherein a communication resource is a frequency band or a frequency carrier or a transmission bandwidth or a transmission power.

6. The base station according to claim 1, further comprising a radio frequency module configured to communicate within a certain frequency band or for communicating within a plurality of certain frequency bands.

7. The base station according to claim 1, wherein the first and the second logical base stations are implemented on a functional circuitry which is programmably arranged to comprise the first logical base station and the second logical base station.

8. The base station according to claim 1, wherein the base station is configured to receive a multiplexed signal, said multiplexed signal comprising a first signal according to the first communication technology and a second signal according to the second communication technology, and
wherein the base station is further configured to extract the first signal or the second signal from the multiplexed signal, and provide the first signal to the first logical base station or provide the second signal to the second logical base station.

9. The base station according to claim 1, further comprising a plurality of logical base stations, wherein each logical base station of the base station is associated with a communication technology, and wherein each logical base station is associated with a different or the same operator of the communication system.

10. The base station according to claim 1, wherein the first communication technology or the second communication technology is one of the following communication technologies:
Universal Mobile Telecommunication System (UMTS); or
Global System for Mobile Communications (GSM); or
Long Term Evolution (LTE); or
Code Division Multiple Access 2000 (CDMA2000).

11. The base station according to claim 9, wherein the communication technology is one of the following communication technologies:
Universal Mobile Telecommunication System (UMTS); or
Global System for Mobile Communications (GSM); or
Long Term Evolution (LTE); or
Code Division Multiple Access 2000 (CDMA2000).

12. A radio communication system, comprising:
a base station having a first logical base station configured to communicate according to a first communication technology and a second logical base station configured to communicate according to a second communication technology, wherein the second communication technology being different from the first communication technology;
a first control node, configured to communicate with the first logical base station according to the first communication technology; and
a second control node, configured to communicate with the second logical base station according to the second communication technology.

13. The communication system according to claim 12, further comprising a multiplexer configured to connect the first control node and the second control node to the base station, wherein the multiplexer is configured to multiplex signals from the first control node and the second control node to obtain a multiplexed signal.

14. The communication system according to claim 12, wherein the first control node is a base station controller or a radio network controller.

15. The communication system according to claim 12, wherein the second control node is a base station controller or a radio network controller.

16. A method for use by a base station capable of communicating in different communication technologies, wherein the base station comprises a first logical base station configured to conduct communications according to a first communication technology, and a second logical base station configured to conduct communications according to a second communication technology, the method comprising:
receiving an incoming signal;
determining whether the incoming signal is provided according to the first communication technology or the second communication technology;
if the incoming signal is provided according to the first communication technology, processing the signal using the first logical base station; and
If the incoming signal is provided according to the second communication technology, processing the signal using the second logical base station;
wherein the second communication technology is different from the first communication technology.

17. The method according to claim 16, wherein the first communication technology or the second communication technology is one of the following communication technologies:
Universal Mobile Telecommunication System (UMTS); or
Global System for Mobile Communications (GSM); or
Long Term Evolution (LTE); or
Code Division Multiple Access 2000 (CDMA2000).

18. A computer program product comprising a readable storage medium configured to store program code thereon for use by a base station comprising a first logical base station configured to conduct communications according to a first communication technology, and a second logical base station configured to conduct communications according to a second communication technology, the program code comprising instructions for executing a method that comprises:
receiving an incoming signal;
determining whether the incoming signal is provided according to the first communication technology or the second communication technology;
if the incoming signal is provided according to the first communication technology, processing the signal using the first logical base station; and
if the incoming signal is provided according to the second communication technology, processing the signal using the second logical base station;
wherein the second communication technology is different from the first communication technology.

19. The computer program product according to claim 18, wherein the first communication technology or the second communication technology is one of the following communication technologies:
Universal Mobile Telecommunication System (UMTS); or
Global System for Mobile Communications (GSM); or
Long Term Evolution (LTE); or
Code Division Multiple Access 2000 (CDMA2000).
